(19) United States
(12) Patent Application Publication
(10) Pub. No.: US 2015/0272239 A1
(43) Pub. Date: Oct. 1, 2015

(54) THUMB PROTECTOR WITH A TETHER

(71) Applicant: Bruce Ian BAZLEY, Kelowna (CA)

(72) Inventor: Bruce Ian Bazley, Kelowna (CA)

(21) Appl. No.: 14/426,826

(22) PCT Filed: Sep. 6, 2013
(86) PCT No.: PCT/CA2013/050691

§ 371 Date: Mar. 9, 2015

Related U.S. Application Data
(60) Provisional application No. 61/698,299, filed on Sep. 7, 2012.

(51) Int. Cl. A41D 13/08; B26B 29/02; A41D 13/05

(52) U.S. Cl. CPC A41D 13/087; A41D 13/0562; B26B 29/02

(57) ABSTRACT

A thumb protector comprises a thumb cap with an opening to receive a thumb of a user. The thumb cap has a padded portion. A tether extends from the thumb cap. The tether is shaped to be releasably coupled to a knife.

### BACKGROUND OF THE INVENTION

1. Field of the Invention

The present invention relates to a thumb protector and, in particular, to a thumb protector with a tether shaped to be releasably coupled to a knife.

2. Description of the Related Art

It is known to use a thumb protector to protect a thumb of a user from cuts and bruises while the user is manipulating a knife to peel or pare an object. For example, U.S. Pat. No. 1,916,921, which issued on Jul. 4, 1922 to Dougan, discloses a thumb protector comprising means for securing itself in place and a unique structure for withstanding a cutting action of a knife edge without affecting normal free movement of the thumb and hand. The thumb protector may be slipped over the thumb. The thumb protector may be made of rubber and may he washed for re-use. A plurality of spherical reinforcing members is disposed within the thumb protector to guard against the cutting action of the knife edge.

### SUMMARY OF THE INVENTION

It is an object of the present invention to provide an improved thumb protector.

There is accordingly provided a thumb protector comprising a thumb cap with an opening to receive a thumb of a user. The thumb cap has a padded portion. A tether extends from the thumb cap. The tether is shaped to be releasably coupled to a knife.

There is also provided a combination of a knife and a thumb protector. The thumb protector comprises a thumb cap with an opening to receive a thumb of a user. The thumb cap has a padded portion. A tether extends from the thumb cap. The tether has a collar extending from a distal end thereof. The collar is shaped to receive the knife and releasably couple the tether to the knife.

There is further provided a finger protector comprising a finger cap with an opening to receive a finger of a user. The finger cap has a padded portion. A tether extends from the finger cap. The tether is shaped to be releasably coupled to a knife.

A first embodiment of the thumb protector comprises a thumb cap with an opening to receive a thumb of a user. The thumb cap has a padded portion. A tether extends from the thumb cap. The thumb cap may be formed of a flexible material. The thumb cap may have a plurality of apertures extending therethrough. The thumb cap may be formed of a porous material. The padded portion of the thumb cap may substantially align with a ball of the thumb when the thumb protector is worn over the thumb. The tether has a collar extending from a distal end thereof. The collar is shaped to receive a knife and releasably couple the tether to the knife.

A second embodiment of the thumb protector comprises a thumb cap formed of a rigid material. The thumb cap has a split. The split is disposed on the thumb cap at a position corresponding to a first knuckle of a thumb.

A third embodiment of the thumb protector comprises a tether with fastener straps extending from a distal end thereof. The fastener straps are shaped to wrap around a knife and engage one another to releasably couple the tether to the knife.

A fourth embodiment of the thumb protector comprises a thumb cap with an opening to receive a thumb of a user. The thumb cap has a padded portion. The tether extends from the thumb cap. The tether has a catch between the base of the thumb cap and a distal end of the tether. The tether has a latch between the catch and the distal end of the tether. The tether is shaped to wrap around a knife. The latch engages the catch to releasably couple the tether to the knife. The catch may be an enlarged portion with an aperture extending therethrough. The latch may he a plurality of spaced-apart enlarged portions.

A fifth embodiment of the thumb protector comprises a thumb cap with an opening to receive a thumb of a user. The thumb cap has a padded portion. The padded portion may be formed of a magnetic material.

### BRIEF DESCRIPTIONS OF DRAWINGS

The invention will be more readily understood from the following description of the embodiments thereof given, by way of example only, with reference to the accompanying drawings, in which:

FIG. 1 is a side elevation view of a first embodiment of an improved thumb protector;

FIG. 2 is a perspective view showing the thumb protector of Figure. 1 coupled to a knife;

FIG. 3 is a perspective view showing the thumb protector of FIG. 1 in use with a knife and mounted on a thumb of a user;

FIG. 4 is a side elevation view of a second embodiment of an improved thumb protector.

FIG. 5 is a perspective view of a third embodiment of an improved thumb protector.

FIG. 6 is a perspective view of the thumb protector of FIG. 5 showing a tether thereof wrapped around a knife;

FIG. 7 is a side elevation view of a fourth embodiment of an improved thumb protector;

FIG. 8 is a perspective view showing the thumb protector of FIG. 7 coupled to a knife; and

FIG. 9 is a side elevation view of a fifth embodiment of an improved thumb protector.

### DESCRIPTIONS OF THE PREFERRED EMBODIMENTS

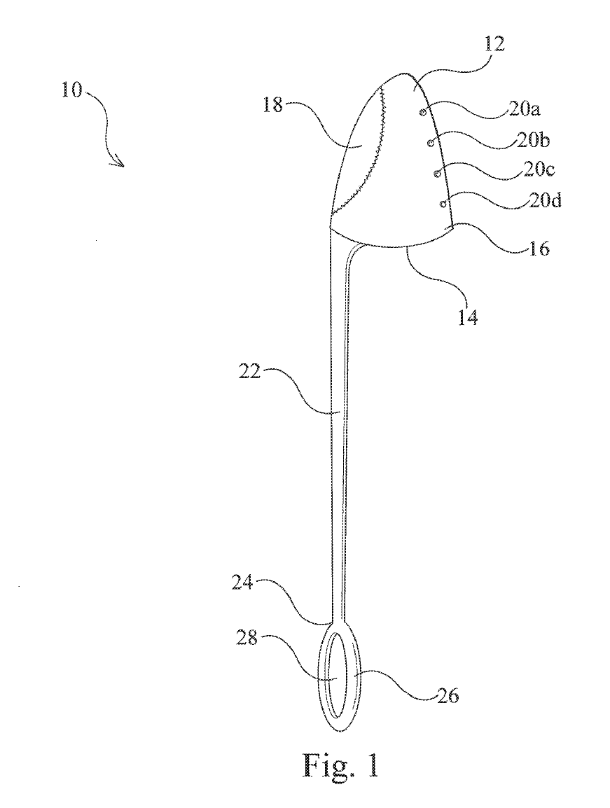

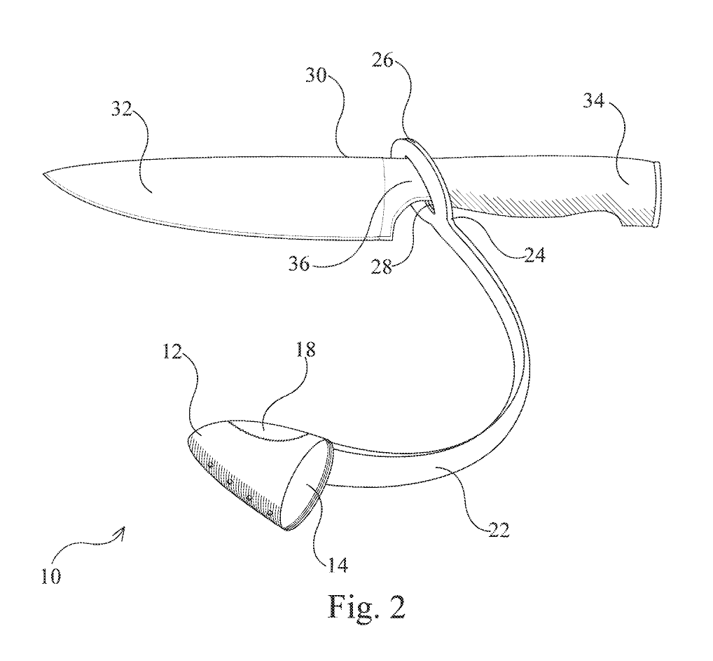

Referring to the drawings and first to FIG. 1, a first embodiment of an improved thumb protector 10 is shown. The thumb protector 10 includes a thumb cap 12 with an opening 14, best shown in FIG. 2, at a base 16 thereof. There is a padded portion 18 on the thumb cap 12 which is resistant to cutting by a knife. There may be apertures, for example, apertures 20a, 20b, 20c and 20d, extending through the thumb cap 12 to allow water to drain during washing of the thumb protector 10. Alternatively, the thumb cap 12 may he formed of a porous material that allows water to drain during washing of the thumb protector 10. There is a tether 22, for example, a flexible strap, extending from the thumb cap 12 adjacent the opening 14 thereof. There is a collar 26 extending from a distal end 24 of the tether 22.

As best shown in FIG. 2, the collar 26 includes an aperture 28 which is sized to receive a knife 30. The knife 30 includes a blade 32, a handle 34 and a neck 36 between the blade 32 and the handle 34. The collar 26 may be releasably coupled. to the knife 30 at the neck 36. This allows the thumb protector 10 to be releasably coupled to the knife 30 by the tether 22. The collar 26 may be formed of a flexible material which allows the aperture 28 to stretch to accommodate various widths of the neck 36. The collar 26 may be formed of a same material as the tether 22.

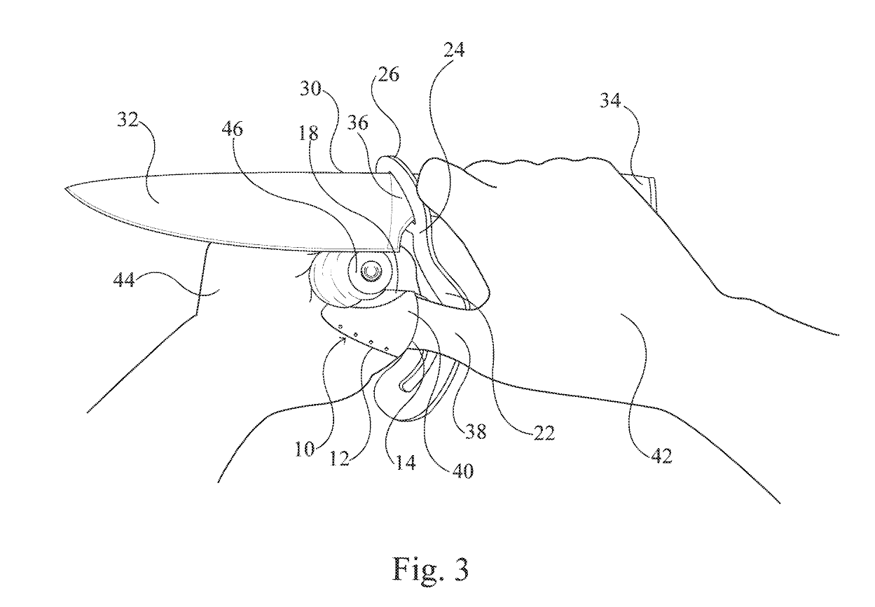

Referring now to FIG. 3, the thumb protector 10 is shown in use with the knife 30. The opening 14 of the thumb cap 12 receives a thumb 38 of a user so that the thumb cap 12 covers at least a distal end of the thumb 38. The padded portion 18 may be substantially aligned with a ball of the thumb 38 when the thumb protector 10 is worn over the thumb 38. The thumb cap 12 may be formed of a flexible material shaped to resiliently conform to and grip the thumb 38. This allows the thumb cap 12 to be secured in place over the thumb 38. In examples where the thumb cap 12 extends past a first knuckle of the thumb 38, the flexible material allows the thumb cap 12 to flex with the thumb 38 during normal articulation of the thumb 38. In this example, the tether 22 extends from the thumb cap 12 at substantially a side 40 of the thumb cap 12 which is a same side that the padded portion 18 is on. This prevents the tether 22 from interfering with insertion of the thumb 38 into the opening 14 of the thumb cap 12 and from interfering with motion of the thumb 38 during use of the thumb protector 10.

The tether 22 is releasably coupled to the neck 36 of the knife 30 by the collar 26 which extends from the distal end 24 of the tether 22. A first hand 42 of a user, which is a same hand from which the thumb 38 extends, grips the knife 30 at the handle 34. A second hand 44 of a user grips an object, in this example, a vegetable 46, to be peeled or pared. The vegetable 46 is held between the blade 32 of the knife 30 and the padded portion 18 of the thumb cap 12 so that the padded portion 18 faces the blade 32 as a user manipulates the knife 30. This allows the thumb 38 to be protected by the cut-resistant padded portion 18 if the blade 32 comes into contact with the thumb cap 12. The padded portion 18 may have a planar surface or a slightly concave surface to accommodate a curved surface of a fruit or vegetable to be peeled or pared. This allows for better grip when holding the fruit or vegetable between the blade 32 and the padded portion 18,

The thumb protector 10 may be formed of a washable material. The tether 22 may be removed from the knife 30 in order to, for example, wash the thumb protector 10 separately from the knife 30. Alternatively, the tether 22 may remain coupled to the knife 30 during washing so that the thumb protector 10 and the knife 30 may be washed together, for example, in a dishwasher for ease and convenience of the user. The tether 22 may also remain coupled to the knife 30 during storage so that the thumb protector 10 and the knife 30 may be stored together for convenience of the user and to save space.

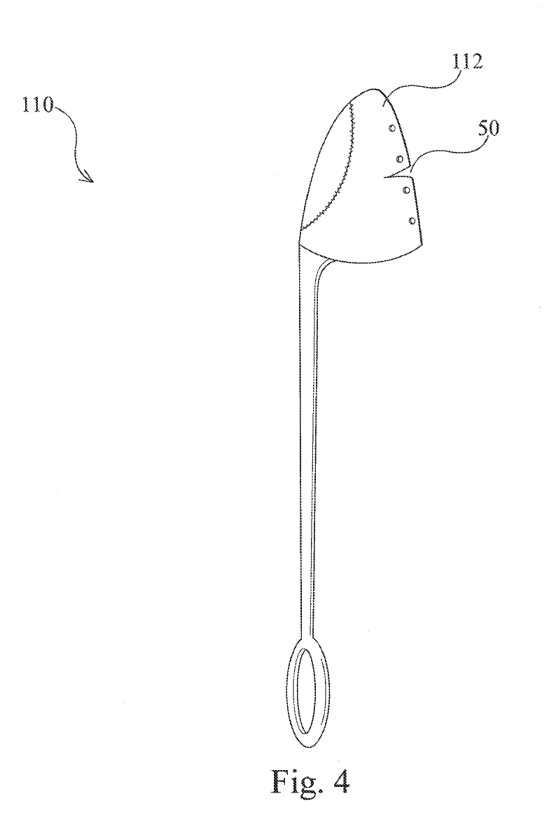

Referring now to FIG. 4, a second embodiment of a thumb protector 110 is shown. The thumb protector 110 is generally similar to the thumb protector 10 shown in FIGS. 1 to 3 with the notable exception that the thumb protector 110 has a thumb cap 112 formed of a rigid material. The thumb cap 112 includes a split 50. The split 50 may be disposed on the thumb cap 112 at a position corresponding to a first knuckle of a thumb. This allows the thumb cap 112 to bend with the thumb so as to not interfere with normal articulation of the thumb.

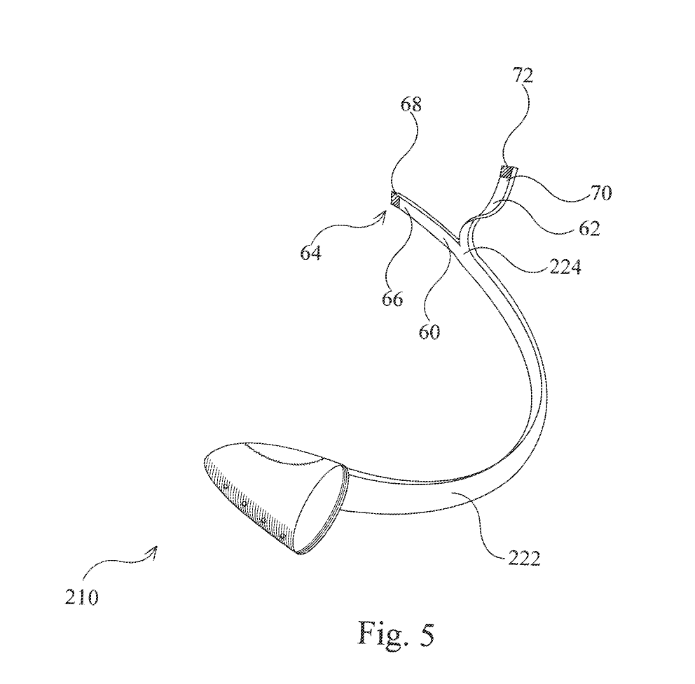

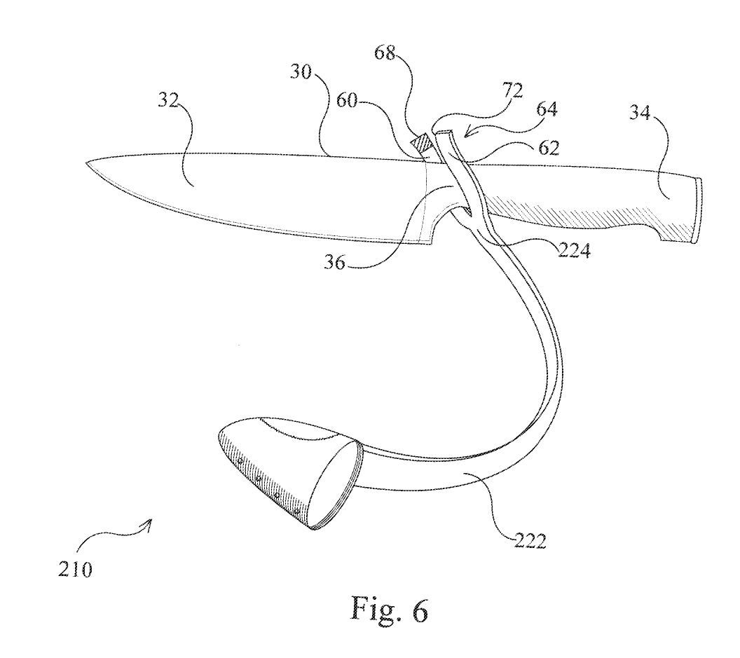

Referring now to FIGS. 5 and 6, a third embodiment of a thumb protector 210 is shown. In FIG. 6, like structures have been given like reference numerals as in FIGS. 1 to 3. The thumb protector 210 is generally similar to the thumb protector 10 shown in FIGS. 1 to 3 with the notable exception that the thumb protector 210 has a bifurcated tether 222 with fasteners straps 60 and 62 extending from a distal end 224 thereof. In this example, the fasteners straps 60 and 62 form a hook-and-loop fastener assembly 64. There is a female hook-and-loop fastener member 68 at a distal end 66 of the fastener strap 60 and a male hook-and-loop fastener member 72 at a distal end 70 of the fastener strap 62. As shown in FIG. 6, the hook-and-loop fastener assembly 64 encircles the neck 36 of the knife 30. The male hook-and-loop fastener member 72 engages the female hook-and-loop fastener member 68 to releasably couple the tether 222 to the knife 30. The hook-and-loop fastener assembly 64 may be adjustably fastened to tighten or loosen the fastener straps 60 and 62 around the neck 36 of the knife 30 to accommodate various widths of the neck 36.

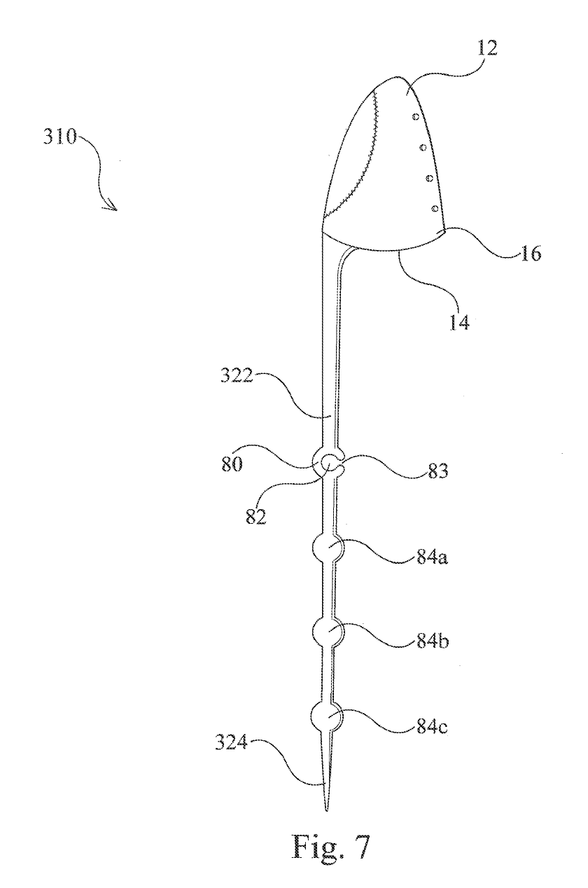

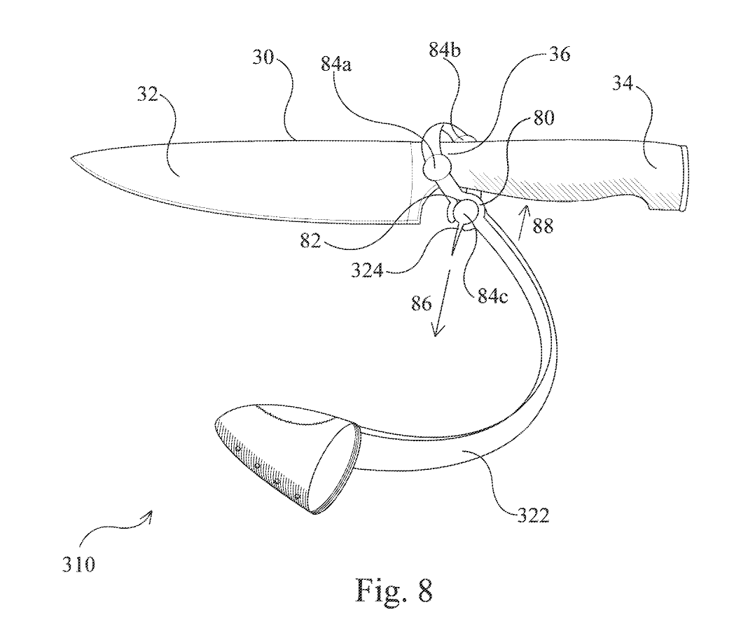

Referring now to FIGS. 7 and 8, a fourth embodiment of a thumb protector 310 is shown. In FIGS. 7 and 8, like structures have been given like reference numerals as in FIGS. 1 to 3. The thumb protector 310 is generally similar to the thumb protector 10 shown in FIGS. 1 to 3 with the notable exception that the thumb protector 310 has a tether 322 with a catch which, in this example, is an enlarged portion 80 with an aperture 82 extending therethrough. The enlarged portion 80 is substantially C-shaped with a slot 83 in this example but may be any shape and may be fully enclosed. The enlarged portion 80 is disposed between the base 16 of the thumb cap 12 and a distal end 324 of the tether 322. There is a latch which, in this example, is a plurality of spaced-apart enlarged portions 84a, 84b and 84c, disposed between the enlarged portion 80 and the distal end 324 of the tether 322. The enlarged portions 84a, 84b and 84c are substantially spherical in this example but may be any shape. As best shown in FIG. 8, the tether 322 encircles the neck 36 of the knife 30 and at least one of the enlarged portions 84a, 84b and 84c is pulled through the aperture 82 of the enlarged portion 80 in a direction generally indicated by arrow 86. This allows the tether 322 to be releasably coupled to the knife 30. The tether 322 may be tightened around the neck 36 of the knife 30 by pulling further enlarged portions 84a, 84b and 84c through the aperture 82 in the direction indicated by arrow 86.

The enlarged portion 80 may be formed of a flexible material which allows the aperture 82 to stretch to receive at least one of the enlarged portions 84a, 84b and 84c when the distal end 324 of the tether 322 is being pulled in the direction indicated by arrow 86. When the tether 322 is not being pulled, the aperture 82 normally does not allow passage of the enlarged portions 84a, 84b and 84c therethrough. This inhibits the enlarged portions 84a, 84b and 84c from moving in a direction generally indicated by arrow 88, which is substantially opposite of the direction indicated by arrow 86, so that the tether 322 will not become loosened or uncoupled from the knife 30. The tether 322 can be uncoupled from the knife 30 by pulling the tether 322 in the direction indicated by arrow 88 so that the aperture 82 stretches to permit passage of the enlarged portions 84a, 84b and 84c therethrough.

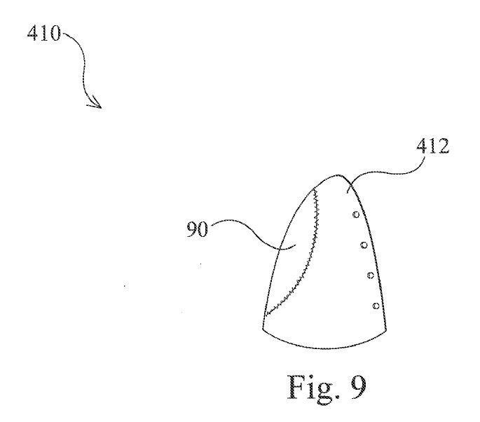

Referring now to FIG. 9, a fifth embodiment of a thumb protector 410 is shown. The thumb protector 410 is generally similar to the thumb protector 10 shown in FIGS. 1 to 3 with the notable exception that the thumb protector 410 has a thumb cap 412 with a padded portion 90 formed of a magnetic material or alternatively has a magnetic material embedded within. The padded portion 90 may adhere magnetically to a magnetic surface (not shown) such as a magnetic knife rack for ease of storage and retrieval of the thumb protector 410.

It will he understood by a person skilled in the art that the thumb protector is described herein protecting a thumb of a user but that the thumb protector may also be used as a finger protector.

It will also be understood by a person skilled in the art that the thumb protector is shown herein peeling or paring a fruit or vegetable by way of example only. The thumb protector may also be used in other applications, for example, in industrial applications cutting rod-like or rope-like materials or stripping plastic covering from electrical wires.

It will further be understood by a person skilled in the art that many of the details provided above are by way of example only, and are not intended to limit the scope of the invention which is to be determined with reference to the following claims.

What is claimed is:

1. A thumb protector comprising:
a thumb cap with an opening to receive a thumb of a user, the thumb cap having a padded portion; and
a tether extending from the thumb cap, the tether being shaped to be releasably coupled to a knife.

2. The thumb protector according to claim 1, wherein the thumb cap is formed of a flexible material.

3. The thumb protector according to claim 1, wherein the thumb cap is formed of a rigid material and has a split.

4. The thumb protector according to claim 3, wherein the split is disposed on the thumb cap at a position corresponding to a first knuckle of the thumb.

5. The thumb protector according to claim 1, wherein the thumb cap has a plurality of apertures extending therethrough.

6. The thumb protector according to claim 1, wherein the thumb cap is formed of a porous material.

7. The thumb protector according to claim 1, wherein the padded portion of the thumb cap substantially aligns with a ball of the thumb when the thumb protector is worn over the thumb.

8. The thumb protector according to claim 1, wherein the tether has a collar extending from a distal end thereof, the collar being shaped to receive the knife and releasably couple the tether to the knife.

9. The thumb protector according to claim 1, wherein the tether has fastener straps extending from a distal end thereof, the fastener straps being shaped to wrap around the knife and engage one another to releasably couple the tether to the knife.

10. A thumb protector comprising:
a thumb cap with an opening to receive a thumb of a user, the thumb cap having a padded portion; and
a tether extending from the thumb cap, the tether having a catch between a base of the thumb cap and a distal end of the tether and a latch between the catch and the distal end of the tether;
wherein the tether is shaped to wrap around a knife and the latch engages the catch to releasably couple the tether to the knife.

11. A thumb protector according to claim 10, wherein the catch is an enlarged portion having an aperture extending therethrough.

12. A thumb protector according to claim 10, wherein the latch is a plurality of spaced-apart enlarged portions.

13. A thumb protector comprising:
a thumb cap with an opening to receive a thumb of a user, the thumb cap having a padded portion;
wherein the padded portion is formed of a magnetic material.

14. In combination, a knife and a thumb protector, the thumb protector comprising a thumb cap with an opening to receive a thumb of a user, the thumb cap having a padded portion, and a tether extending from the thumb cap, the tether having a collar extending from a distal end thereof, the collar being shaped to receive the knife and releasably couple the tether to the knife.

15. A finger protector comprising:
a finger cap with an opening to receive a finger of a user, the finger cap having a padded portion; and
a tether extending from the finger cap, the tether being shaped to be releasably coupled to a knife.
